(19) United States
(12) Patent Application Publication
(10) Pub. No.: US 2020/0407828 A1
(43) Pub. Date: Dec. 31, 2020

(54) ALUMINUM ALLOYS FOR ADDITIVE MANUFACTURING

(71) Applicant: The Penn State Research Foundation, University Park, PA (US)

(72) Inventor: Richard P. Martukanitz, University Park, PA (US)

(21) Appl. No.: 16/971,156

(22) PCT Filed: Mar. 12, 2019
(86) PCT No.: PCT/US2019/021789

§ 371 Date: Aug. 19, 2020

Related U.S. Application Data
(60) Provisional application No. 62/642,076, filed on Mar. 13, 2018.

(51) Int. Cl. C22C 21/16; B22F 1/00; B22F 3/105

(52) U.S. Cl. CPC C22C 21/16; B33Y 70/00; B22F 3/1055; B22F 1/0011

(57) ABSTRACT

An aluminum alloy in powder or wire form specifically formulated for additive manufacturing can include predominately aluminum and about 5-9% copper, about 1-5% silver, and optionally 0.1%-0.6% magnesium, and up to 0.5% of titanium and up to 0.5% of zirconium. Advantageously, the alloy does not include more than 0.15% of other elements with each other element not exceeding 0.05%.

### CROSS-REFERENCE TO RELATED APPLICATION

This application claims the benefit of U.S. Provisional Application No. 62/642,076 filed 13 Mar. 2018, the entire disclosure of which is hereby incorporated by reference herein.

### TECHNICAL FIELD

The present disclosure relates to aluminum based alloys in powder or wire form for additive manufacturing.

### BACKGROUND

Aluminum alloys with copper, silver and magnesium are known. See U.S. Patent Application Publication No. 2016-0115577; US 81118150; U.S. Pat. Nos. 5,389,165; 3,475,166; and 3,288,601 and WO 1989 001 531. However, the vast majority of materials utilized for additive manufacturing processes have involved existing alloys that were developed many years ago based upon production through wrought or foundry technologies. These existing materials were not developed to provide for the unique requirements of the additive manufacturing process, such as energy attenuation of the powder, nor to respond to the unique attributes of additive manufacturing processes, such as high cooling rates and rapid solidification events.

Hence, many existing alloys that are used for additive manufacturing processes do not develop prime mechanical properties or produce optimal surface finish and feature quality, which are highly beneficial for these near net shape or net shape processes. Also, because additive manufacturing involving metallic materials usually necessitates local melting and solidification, alloys used in these processes must possess a relatively high level of insensitivity to solidification cracking. In most instances, the selection of an alloy having freedom from solidification cracking, which is based on the alloy's composition, may not be appropriate to achieve adequate properties and characteristics.

Hence there is a continuing need for alloys, particularly aluminum alloys, designed for additive manufacturing.

### SUMMARY OF THE DISCLOSURE

An advantage of the present disclosure is an aluminum alloy in various forms designed and used in additive manufacturing.

These and other advantages are satisfied, at least in part, by an aluminum alloy in forms suitable for additive manufacturing such as in powder form or wire form. The alloy includes predominately aluminum and certain amounts of copper (e.g., about 5-9%) and silver (about 1-5%) and can include magnesium (up to about 0.6%), titanium (up to about 0.5%), zirconium (up to about 0.5%).

Another aspect of the present disclosure includes preparing a product including an aluminum alloy by additive manufacturing. The process comprises forming the product at least in part from an aluminum alloy in powder form or wire form, wherein the aluminum alloy in powder or wire form includes copper (e.g., about 5-9%) and silver (about 1-5%) and can include magnesium (up to about 0.6%), titanium (up to about 0.5%), zirconium (up to about 0.5%) with the balance of the alloy being aluminum.

Embodiments include any one or more of the features described for the aluminum alloy and its use in additive manufacturing such as in powder or wire form and process of manufacturing parts at least in part with the aluminum alloy in powder form or wire form via additive manufacturing and/or any one or more of the following features, individually or combined. For example, in one embodiment the aluminum alloy includes predominately aluminum, about 5-8% copper, about 1-5% silver, and optionally 0.1-0.6% magnesium, and up to 0.3% of titanium and up to 0.3% of zirconium. In another embodiment, the aluminum alloy includes predominately aluminum, about 8-9% copper, about 1-5% silver, and optionally 0.1-0.6% magnesium, and up to 0.5% of titanium and up to 0.5% of zirconium. In further embodiments, any one or all of magnesium, titanium and zirconium are present in the alloy. Advantageously, the alloys do not include more than 0.15% of other elements with each other element not exceeding 0.05%.

Additional advantages of the present invention will become readily apparent to those skilled in this art from the following detailed description, wherein only the preferred embodiment of the invention is shown and described, simply by way of illustration of the best mode contemplated of carrying out the invention. As will be realized, the invention is capable of other and different embodiments, and its several details are capable of modifications in various obvious respects, all without departing from the invention. Accordingly, the drawings and description are to be regarded as illustrative in nature, and not as restrictive

### BRIEF DESCRIPTION OF THE DRAWINGS

Reference is made to the attached drawings, wherein elements having the same reference numeral designations represent similar elements throughout and wherein:

FIG. 1 is a chart showing hardness measurements after aging sample compositions obtained at the top of the deposit, which represent the initial powder compositions.

FIG. 2 is a chart showing hardness measurements after aging sample compositions obtained at the interface of the deposit and base metal, which represent the initial powder compositions along with a small amount of magnesium due to dilution.

FIG. 3 is a plot showing harness versus weight percent of copper for specimen number 6 after solutionizing at 510° C. and aging at 160° C. for 20 hours wherein the amount of copper in the alloy was corrected based on experimental analysis.

FIG. 4 is a plot showing harness versus weight percent of silver for specimen number 6 after solutionizing at 510° C. and aging at 160° C. for 20 hours wherein the amount of copper in the alloy was corrected based on experimental analysis.

### DETAILED DESCRIPTION OF THE DISCLOSURE

The present disclosure relates to a formulated aluminum alloy specifically designed for additive manufacturing. The properties and characteristics that are most desirable for alloys used in additive manufacturing processes are and include: high resistance to solidification and post solidification cracking, ability to produce sound material (minimization of gas porosity and voids within the additive manufacturing build), capacity to develop relatively high strength either in the as-build or post process heat treated conditions, and the capability to produce good surface finish and high feature definition.

The aluminum alloy of the present disclosure can be in a form useful for additive manufacturing including powder form and wire form. Although it is possible that elemental powder may be blended to achieve aluminum alloy compositions according to the present disclosure, a better practice would be the pre-alloying to produce a billet, followed by atomization of the billet material to produce powder. The alloy is advantageously in powder form having an average particle diameter useful for additive manufacturing such as in the range of from approximately 10 microns (μm) to approximately 300 microns (μm), depending upon the particular additive manufacturing process. For example, the powder bed fusion (PBF) processes typically requires a smaller range of powder size while the directed energy deposition (DED) processes utilize larger diameter powder for improved feeding.

A compositional range for the alloy intended as a powder product, along with the rationale used for establishing this composition, are described below.

Aluminum alloys of the present disclosure include those in powder or wire form in a compositional range of from about 5% to about 9% copper, from about 1% to about 5% silver and optionally up to about 0.6% magnesium, up to about 0.5% titanium and up to about 0.5% zirconium with the balance being aluminum and inevitable impurities. All percentages of elements in the aluminum alloy are based on weight percent.

In certain embodiments, the aluminum alloy of the present disclosure will contain approximately 5 to 8 percent copper. When strength of the aluminum alloy is a priority, the aluminum alloy will include from about 8% to about 9% copper.

Copper is a well-known addition in aluminum for developing strengthening precipitates based on the CuAl₂ phase and its precursors. However, most commercial aluminum alloys do not exceed 6 percent copper. Greater additions of copper may be used to decrease solidification cracking tendencies, especially when copper is used in combination with magnesium. Although there are other alloying additions that may be used for precipitation strengthening of aluminum, copper addition to aluminum has the unique attribute of not altering the surface tension of the aluminum-copper alloy in the liquid state. This is advantageous for maintaining the shape of the small molten pool for achieving good surface finish and high feature resolution. The higher reflectivity of an aluminum alloy containing copper also has benefits when it is used in powder form during the laser-based powder bed fusion process, an additive manufacturing process that is most prevalent. Because of the higher reflectivity of the of the individual powder particles, the reflections to other powder particles result in less attenuation, or greater penetration of energy within the preplaced powder when used with the PBF process and, thus creating a more uniform molten state throughout the depth of the powder layer.

In combination with copper, the alloy will also contain approximately 1 to 5 percent silver. Silver has not been used commercially in aluminum alloys because of cost, and hence, has not been significantly studied. However, it is known that silver may also be used as a precipitation strengthening phase (AlAg), and may also be used to significantly increase the strength of aluminum alloys containing copper and magnesium after precipitation heat treating. It is also believed that silver does not have a deleterious effect on solidification crack sensitivity when added to aluminum. Silver is also one of the few elements that does not lower the surface tension of the alloy in the liquid state. Is also has the effect of increasing the reflectivity of the alloy, thus aiding penetration of the laser energy through the powder depth.

In combination with copper and silver, the aluminum alloy can also include up to 0.6 percent magnesium, e.g. from approximately 0.1 to 0.6 percent magnesium. Magnesium can be added to improve the response of the alloy to precipitation strengthening with copper. It is believed that some pairing of copper and magnesium atoms contribute to the precipitation strengthening process, potentially through the development of the Al₂CuMg phase. Although magnesium is used to aid the strengthening of the alloy, its level of addition is limited to maintain freedom from cracking during solidification. Higher levels of magnesium also tend to form magnesium oxide (MgO) islands on the inherent aluminum oxide (Al₂O₃), which would be present on the surface of powder particles. The magnesium oxide could hydrate during handling and storage and result in hydrogen porosity during the additive manufacturing process. Hence, no more than about 0.6 percent magnesium should be included in the aluminum alloy.

In combination with copper and silver and optionally magnesium, the alloy can also contain secondary alloying additions of titanium and zirconium up to 0.5% each, such as up to 0.3 percent each. These additions are added as grain refiners to minimize grain growth during solidification and cooling of the additive manufacturing process. Minimization of grain growth will improve mechanical properties and aid in suppressing solidification cracking.

Hence, the aluminum alloys of the present disclosure can include, in addition to about 5-8% copper and about 1-5% silver, any one or all of magnesium, titanium, zirconium, e.g., magnesium can be included in the alloy from greater than 0% to about 0.6%, titanium can be included in the alloy from greater than 0% to about 0.5%, zirconium can be included in the alloy from greater than 0% to about 0.5% or any combination of Mg, Ti, Zr can be present in the alloy at the respective ranges.

In combination with copper and silver and optionally magnesium and up to 0.5% of titanium and up to 0.5% of zirconium, the aluminum alloy should preferably not include more than 0.15 percent of another element, with each other element not exceeding 0.05 percent in itself. That is, apart from Al, Cu, Ag, Mg, Ti, Zr, the aluminum alloys of the present disclosure preferably do not include more than 0.15 percent of another element, with each other element not exceeding 0.05 percent in itself. This is invoked to minimize the formation of undesirable phases that may increase solidification cracking and reduce mechanical properties.

In an embodiment of the present disclosure, an aluminum alloy in powder or wire form consists of about 5-9% copper, about 1-5% silver, and optionally 0.1-0.6% magnesium, and up to 0.5% of titanium and up to 0.5% of zirconium, wherein the alloy will not include more than 0.15% of other elements with each other element not exceeding 0.05%, with the balance of the alloy being aluminum. In another embodiment of the present disclosure, an aluminum alloy in powder form consists of about 5-8% copper, about 1-5% silver, and optionally 0.1-0.6% magnesium, and up to 0.3% of titanium and up to 0.3% of zirconium, wherein the alloy will not include more than 0.15% of other elements with each other element not exceeding 0.05%, with the balance of the alloy being aluminum. In certain embodiments, the copper can range from about 5.0% to about 9.0%, from about 5.0% to about 8.0%, from about 6.0% to about 7.5%, from about 8.0% to about 9.0%, or from about 8.2% to about 9.0%; the silver can range from about 2.0% to about 5.0%, from about 2.0% to about 4.0%, from about 3.0% to about 4.5%, or from about 3.8% to about 4.4%; the magnesium can range from about 0.1% to about 0.5% or from about 0.1% to about 0.4%; the titanium can range from about 0.1% to about 0.5% or from about 0.2% to about 0.4%; the zirconium can range from about 0.1% to about 0.5% or from about 0.2% to about 0.4%; or any combination or subcombination thereof.

The aluminum alloys of the present disclosure can be used in additive manufacturing to produce products including the alloy such as aerospace components that may be used for general aircraft construction, such brackets, housings, etc., as well as major structural components, such as bulkheads, stiffened plates, etc. Although the alloys presented in this disclosure may have great applicability within the aerospace industry, components produced using these alloys may also have wide applicability throughout various sectors where light weight, good strength, and good corrosion resistances are important. This would include the marine industry, automotive industry, recreational industry, device industry, and machinery industry, to name a few. Products served by these industries will utilize a wide range of additive manufacturing processes, with the two primary processes being PBF and DED. For both of these processes, high energy sources, such as a laser beam, electron beam, or electric arc are used to melt and deposit material layer by layer to achieve a three-dimensional geometry, which may or may not require post-process machining to achieve the final shape and dimensions. The material or alloy used during these processes are usually in powder form; however, in some instances, wire may also be used as the feedstock. Although the alloys that are the subject of this disclosure are extremely relevant to powder material, much of the benefits associated with these alloys may also be operable in a wire form. The PBF process uses a thin layer of power to “recoat” the bed prior to selectively melting the pattern that forms the layer; whereas, the DED process utilizes powder blown from the moving processing head into the laser beam, causing melting and deposition. Because of how the powder is provided, the PBF process utilizes smaller power that may be easily spread over the bed in a uniform, thin layer; whereas, the DED process requires a larger diameter of powder than may be fed from the hopper through lines to the processing head.

### Examples

The following examples are intended to further illustrate certain preferred embodiments of the invention and are not limiting in nature. Those skilled in the art will recognize, or be able to ascertain, using no more than routine experimentation, numerous equivalents to the specific substances and procedures described herein.

To validate this rationale, an experiment (Experiment 1) was conducted by blending elemental powders representing relatively pure aluminum, copper, and silver to achieve predetermined compositions. The blended powder representing these compositions where then deposited using the laser-based directed energy process by melting the powder with a ytterbium fiber laser and depositing the material onto an aluminum alloy plate containing approximately 2.5 percent magnesium. This enabled the compositions of the deposited material to represent predefined aluminum alloys through the original blended powder, as well as through some dilution from the base plate. By choosing the position within the deposit, compositions of the starting powder could be evaluated. Regions near the base plate interface that had experienced melting would represent the powder composition along with approximately 0.5% magnesium resulting from some dilution of the base plate. The experimental compositions that were created are shown below and have been approximated at this stage. The + in the sample compositions below indicate the original powder composition with a small amount of magnesium being added based upon dilution of magnesium from the base plate.

Sample 2: Balance aluminum with 4 percent copper and 2 percent silver.

Sample 2+: Balance aluminum with 4 percent copper, 2 percent silver, and 0.5 percent magnesium.

Sample 3: Balance of aluminum with 8 percent copper and 2 percent silver

Sample 4: Balance of aluminum with 8 percent copper and 4 percent silver

Sample 4+: Balance of aluminum with 8 percent copper, 4 percent silver, and 0.5 percent magnesium.

Deposits using conventional alloys representing pre-alloyed powder were also produced for comparison purposes. This included a commercial wrought alloy 2219 (aluminum with 6.3 copper) and a commercial powder alloy by EOS (aluminum with 10 percent silicon and 0.5 percent magnesium) used extensively for additive manufacturing. Using the same process as described above, four alloy depositions were produced based on the two initial powder compositions, along with two additional compositions based on a small amount of magnesium due to dilution of the substrate. These alloy samples are also shown below.

Sample 5: Balance aluminum with 6.3 percent copper.

Sample 5+: Balance aluminum with 6.3 percent copper and 0.5 percent magnesium.

Sample 6: Balance of aluminum with 10 percent silicon and 0.5 percent magnesium.

Sample 6+: Balance of aluminum with 10 percent silicon and 1.0 percent magnesium.

Specimens approximately 50 mm long, 12 mm wide, and 18 mm high were produced by multiple deposition tracks using the experimental material. After deposition, the specimens were examined visually, and then sections for metallographic analysis of the as-deposited microstructure. Specimens 3 and 4 showed noticeable improvement in surface finish when compared to the other specimens, with Specimen 4 having the most ideal surface appearance.

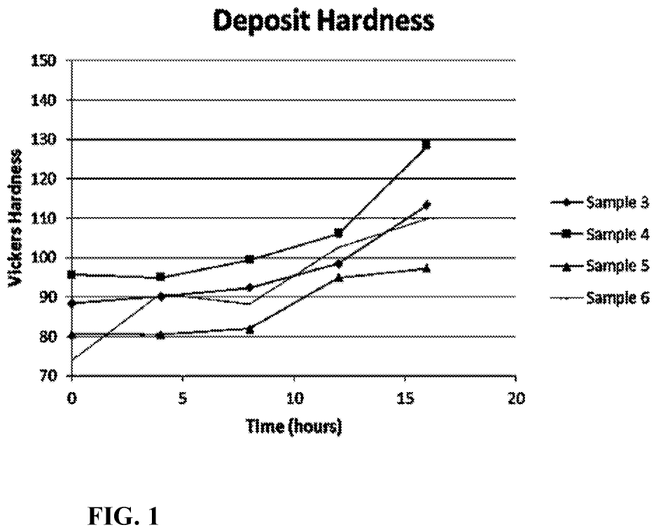

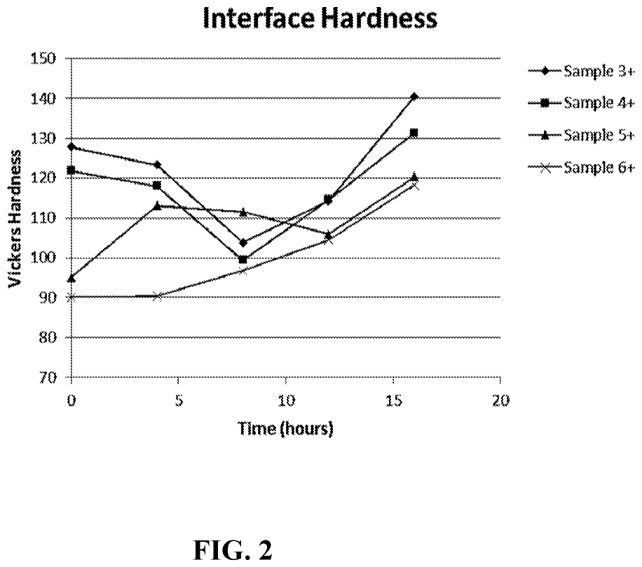

Selected specimens were also subjected to an extensive post process heat treatment study involving solution heat treating and aging for achieving precipitation strengthening. After heat treating, the samples were hardness tested using a Vicker hardness measurement to ascertain strength. The results of these evaluations, which represented solution heat treatment followed by aging at different times, are shown below for the as-deposited compositions (Alloys 3, 4, 5, and 6) and the interface compositions (Samples 3+, 4+, 5+, and 6+) in FIGS. 1 and 2, respectively.

The results indicate that the alloys that were created to emulate the conceived alloy composition (Samples 3, 3+, 4, and 4+) exhibited significant improvement in strength (hardness) when compared to the conventional alloys (Samples 5 and 6). A direct comparison may be made between Samples 3+ and 4+ compared to Samples 5 and 6. It should also be noted that the only current commercial aluminum alloy powder used for additive manufacturing, the EOS alloy (Sample 6), is not recommended for post process heat treating. Hence, when the experimental alloy that embodies the conceived composition (Sample 4+) after heat treatment is compared to the EOS alloy (Sample 6) without post process heat treatment, an increase in hardness of the conceived alloy, and potentially strength, is found to exceed 40 percent. The “aging curves” below also indicate greater strengths may be achieved at longer aging times.

In another example (Example 2), a pre-alloyed powder was produced to represent a nominal composition of aluminum with 0.35% Mg, 0.30% Ti, and 0.30% Zr. This powder was used as a master alloy for blending of relatively pure Cu and Ag powder to achieve various compositions within the range discussed in the Detailed Description of the Disclosure. Similar to Example 1 above, the blended powders representing the experimental compositions where then deposited using the laser-based directed energy process by melting the powder with a ytterbium fiber laser and depositing the material onto an aluminum alloy plate. The deposited materials were characterized using various techniques to measure chemistry, microstructures, and hardness of the deposited materials, in both the as-deposited and post-process heat treated conditions. Initial analysis of the as-deposited materials indicated no visible signs of solidification cracking.

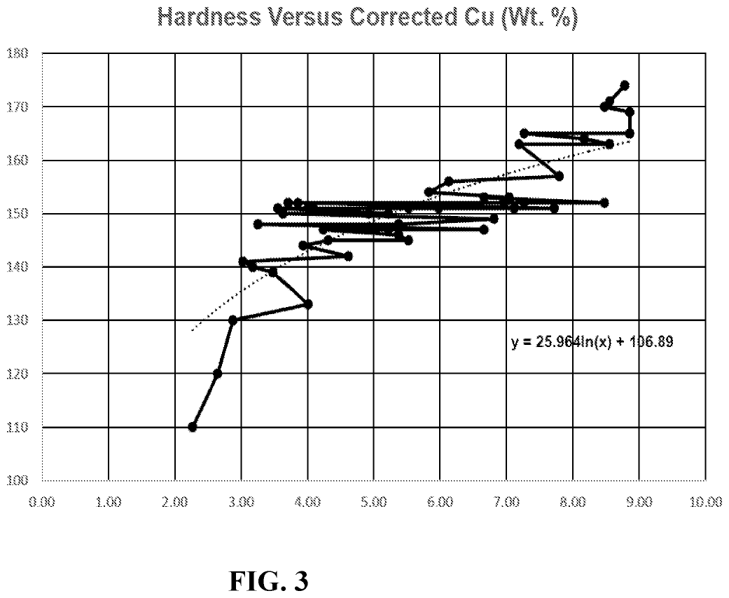

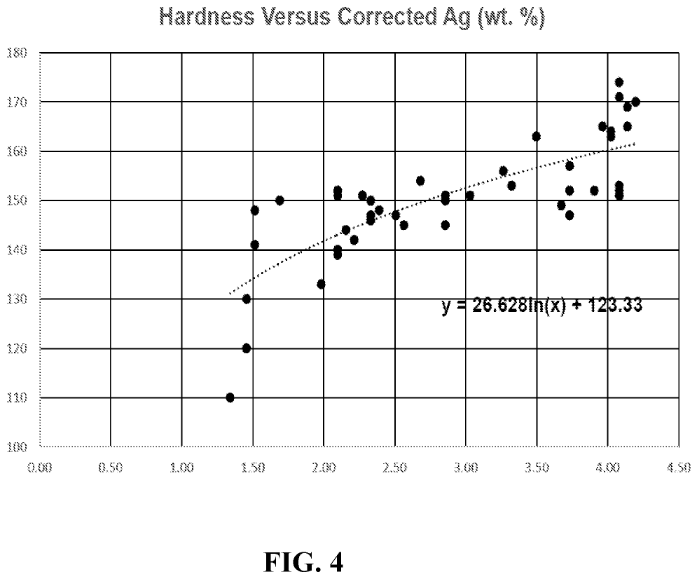

Detailed compositional analysis of the alloys including Al, Cu, Ag, Mg, Ti, Zr, within the ranges provided in Experiment 2 and representing compositions of the present disclosure were also undertaken and compared for hardness. For example, energy-dispersive x-ray spectroscopy (EDS) was used to do a complete survey of composition and hardness from many regions for certain specimens and then compared to earlier inductively coupled plasma spectroscopy (ICPS) compositional measurements from a similar region to calibrate the complete set of data from the EDS survey. The results for the corrected compositional data for Cu and Ag in an aluminum alloy is shown in FIGS. 3 and 4. Based on these results, an aluminum alloy including Cu from 8.2 to 9.0 wt. % and Ag from 3.8 to 4.4 wt % would develop strength approaching and exceeding a commercial aluminum alloy 7075-T651.

Only the preferred embodiment of the present invention and examples of its versatility are shown and described in the present disclosure. It is to be understood that the present invention is capable of use in various other combinations and environments and is capable of changes or modifications within the scope of the inventive concept as expressed herein. Thus, for example, those skilled in the art will recognize, or be able to ascertain, using no more than routine experimentation, numerous equivalents to the specific substances, procedures and arrangements described herein. Such equivalents are considered to be within the scope of this invention, and are covered by the following claims.

1. An aluminum alloy in powder or wire form includes about 5-9% copper, about 1-5% silver, and optionally 0.1-0.6% magnesium, and up to 0.5% of titanium and up to 0.5% of zirconium, wherein the alloy does not include more than 0.15% of other elements with each other element not exceeding 0.05%, with the balance of the alloy being aluminum.

2. An aluminum alloy in powder or wire form includes about 8-9% copper, about 1-5% silver, and optionally 0.1%-0.6% magnesium, and up to 0.5% of titanium and up to 0.5% of zirconium, wherein the alloy does not include more than 0.15% of other elements with each other element not exceeding 0.05%, with the balance of the alloy being aluminum.

3. An aluminum alloy in powder or wire form includes about 5-8% copper, about 1-5% silver, and optionally 0.1%-0.6% magnesium, and up to 0.3% of titanium and up to 0.3% of zirconium, wherein the alloy does not include more than 0.15% of other elements with each other element not exceeding 0.05%, with the balance of the alloy being aluminum.

4. The aluminum alloy of claim 1, wherein the silver is in the range of from about 3.8 to about 4.4.

5. The aluminum alloy of claim 1, wherein the magnesium is in the range of 0.1% to 0.4%.

6. The aluminum alloy of claim 1, wherein the alloy includes titanium or zirconium.

7. The aluminum alloy of claim 1, wherein the alloy includes titanium and zirconium.

8. The aluminum alloy of claim 1, wherein the alloy includes titanium or zirconium each in the range of 0.2% to 0.4%.

9. The aluminum alloy of claim 1, wherein the alloy includes titanium and zirconium each in the range of from about 0.2% to about 0.4%.

10. The aluminum alloy of claim 1, wherein the aluminum alloy is in powder form.

11. The aluminum alloy of claim 10, wherein the powder has an average particle diameter in the range of from approximately 10 microns (pm) to approximately 300 pm.

12. A process for preparing a product including an aluminum alloy by additive manufacturing, the process comprising forming the product at least in part from an aluminum alloy of claim 1.
